(19) United States
(12) Patent Application Publication
(10) Pub. No.: US 2026/0336578 A1
(43) Pub. Date: Oct. 29, 2026

(54) VEHICULAR BRAKING DEVICE

(71) Applicant: ADVICS CO., LTD., Kariya-shi, Aichi-ken (JP)

(72) Inventor: Yusaku YAMAMOTO, Kariya-shi, Aichi-ken (JP)

(73) Assignee: ADVICS CO., LTD., Kariya-shi, Aichi-ken (JP)

(21) Appl. No.: 19/486,118

(22) PCT Filed: May 24, 2024
(86) PCT No.: PCT/JP2024/019272

§ 371 Date: Nov. 20, 2025

(30) Foreign Application Priority Data
May 26, 2023 (JP) 2023-087218

(51) Int. Cl. B60T 8/174; B60T 8/171; B60T 8/172

(52) U.S. Cl. CPC B60T 8/174; B60T 8/171; B60T 8/172

(57) ABSTRACT

A vehicular braking device includes a storage unit that stores a control profile indicating transitions in target values for a first braking force generated by a first braking device having a relatively short response time and a second braking force generated by a second braking device having a relatively long response. A setting unit derives a first response time for the first braking device and a second response time for the second braking device at a control target point in time based on the control profile and sets lead times based on the first response time and the second response time, and a generation unit generates braking requests for the first and second braking devices based on the target values for the first braking force and the second braking force that correspond to a point in time ahead of the control target point in time by the lead times.

### TECHNICAL FIELD

The disclosure here relates to a vehicular braking device.

### BACKGROUND ART

Patent Literature 1 discloses a technique of obtaining a regenerative braking force and a hydraulic braking force based on a torque command value and a hydraulic command value output from a hydraulic/torque command value calculation unit.

### CITATION LIST

### Patent Literature

Patent Literature 1: JP 2016-28913 A

### SUMMARY

### Technical Problem

An object of an aspect of the present disclosure is to provide a vehicular braking device capable of performing braking control with high accuracy.

### Solution to Problems

In order to solve the above problem, a vehicular braking device according to an aspect of the present disclosure is applied to a vehicle including a first braking device having a relatively short response time from an input of a braking request to generation of a braking force to be applied to the vehicle and a second braking device having a relatively long response time, and adjusts a first braking force generated by the first braking device and a second braking force generated by the second braking device to apply, to the vehicle, a braking force corresponding to a braking request to the vehicle, the vehicular braking device includes a storage unit that Stores a control profile indicating transitions of target values of the first braking force and the second braking force during a control target period, and a setting unit that derives a first response time that is the response time of the first braking device and a second response time that is the response time of the second braking device at a control target point in time based on the control profile stored in the storage unit, and sets a lead time based on the first response time and the second response time, and a generation unit that generates a braking request for the first braking device and the second braking device based on target values of the first braking force and the second braking force corresponding to a point in time ahead of the control target point in time by the lead time set by the setting unit in the control profile stored in the storage unit.

### Advantageous Effects

According to an aspect of the present disclosure, it is possible to provide a vehicular braking device capable of performing braking control with high accuracy.

### BRIEF DESCRIPTION OF DRAWINGS

FIG. 1 is a plan view schematically illustrating an overall configuration of a vehicle including a vehicular braking device according to the first embodiment of the present disclosure.

FIG. 2(a)-2(e) are diagrams used for describing the braking assistance control, and is a diagram illustrating control for stopping a vehicle by the regenerative braking force.

FIG. 3(a)-3(e) are diagrams used for describing the braking assistance control, and is a diagram illustrating control for stopping the vehicle by the friction braking force.

FIG. 4(a)-4(e) are diagrams used to describe the lead time, and is a diagram illustrating control of Stopping the vehicle by the friction braking force.

FIG. 5 is a flowchart illustrating a flow of processing of braking assistance control in the vehicular braking device according to the first embodiment of the present disclosure.

FIG. 6 is a diagram used for describing hydraulic overshoot.

### DESCRIPTION OF EMBODIMENTS

### First Embodiment

### (Configuration of Vehicular Braking Device)

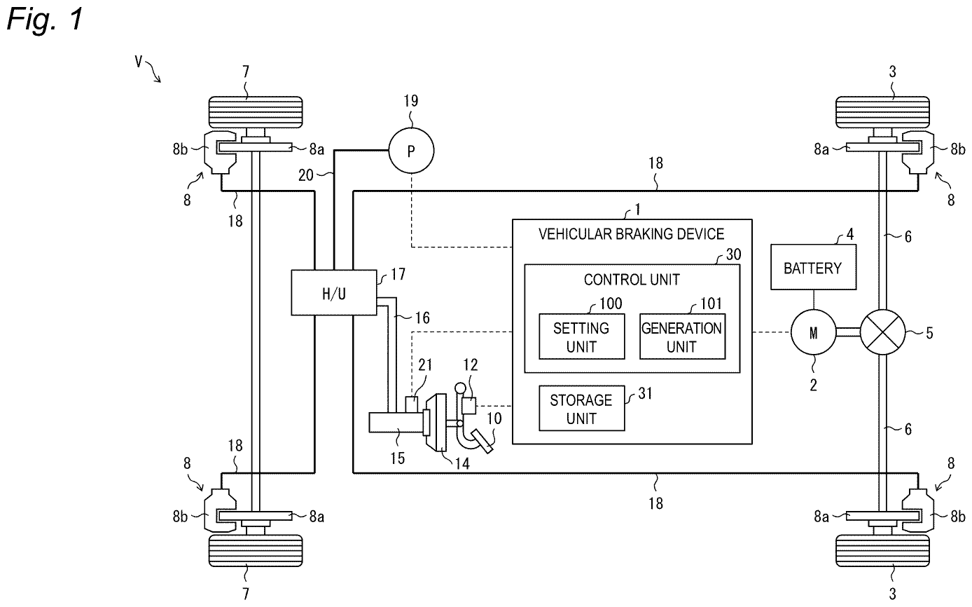

FIG. 1 is a plan view schematically illustrating an overall configuration of a vehicle including a vehicular braking device according to the first embodiment of the present disclosure. A vehicle V illustrated in FIG. 1 includes a vehicular braking device 1, a motor 2, a rear wheel 3, a battery 4, a differential device 5, an axle 6, a front wheel 7, a friction brake 8, a brake pedal 10, a brake switch 12, a brake booster 14, a master cylinder 15, a first hydraulic pipe 16, a hydraulic unit (H/U) 17, a second hydraulic pipe 18, a hydraulic pump 19, a third hydraulic pipe 20, and a hydraulic sensor 21.

The vehicular braking device 1 includes a control unit 30 and a storage unit 31. The control unit 30 is, for example, a central processing unit (CPU), and reads and executes a program from the storage unit 31.

The storage unit 31 includes, for example, a hard disk drive (HDD), a solid state drive (SSD), and the like. The storage unit 31 stores a program to be executed by the control unit 30. Furthermore, the storage unit 31 includes a random access memory (RAM) and the like to be used as a work space by the control unit 30.

The motor 2 is a drive source that rotationally drives the left and right rear wheels 3 of the vehicle V. The motor 2 is electrically connected to the battery 4 and operates by electric power supplied from the battery 4. The rotational driving force of the motor 2 is distributed by the differential device 5 and transmitted to the left and right axles 6.

The friction brakes 8 are provided on the left and right rear wheels 3 and the left and right front wheels 7 of the vehicle V. These four friction brakes 8 are an example of a second braking device. Each of the friction brakes 8 includes a brake disc 8a and a brake caliper 8b.

The master cylinder 15 is connected to the H/U 17 via the first hydraulic pipe 16. The four second hydraulic pipes 18 and the one third hydraulic pipe 20 are connected to the H/U 17. The four second hydraulic pipes 18 connect the H/U 17 and the friction brakes 8 provided on the left and right rear wheels 3 and the left and right front wheels 7. The third hydraulic pipe 20 connects the H/U 17 and the hydraulic pump 19. The master cylinder 15 is provided with the hydraulic sensor 21. The hydraulic sensor 21 is electrically connected to the vehicular braking device 1. The hydraulic sensor 21 detects the hydraulic pressure in the master cylinder 15.

When the vehicle V is decelerating, the motor 2 functions as a generator and recovers part of kinetic energy as electric energy. At this time, the motor 2 functions as a regenerative brake that generates regenerative braking force. The motor 2 functioning as a regenerative brake is an example of a first braking device. The regenerative braking force is an example of a first braking force.

The master cylinder 15 is connected to the brake pedal 10 via the brake booster 14. When the driver of the vehicle V depresses the brake pedal 10, a hydraulic pressure having a magnitude corresponding to a brake operation amount, which is an amount of depressing the brake pedal 10, is generated in the master cylinder 15. The hydraulic pressure generated by the master cylinder 15 is supplied to each friction brake 8 via the first hydraulic pipe 16, the H/U 17, and the second hydraulic pipe 18. The friction braking force is generated in each friction brake 8 by this hydraulic pressure, and braking is applied to the rotation of the left and right front wheels 7 and the rear wheels 3. The friction braking force is an example of a second braking force.

The driving of the hydraulic pump 19 is controlled by the vehicular braking device 1. The vehicular braking device 1 can supply hydraulic pressure to the friction brake 8 by driving the hydraulic pump 19 even when the brake pedal 10 is not depressed. Also by this hydraulic pressure, the friction braking force is generated in each friction brake 8, and braking can be applied to the rotation of the left and right front wheels 7 and the rear wheels 3. This friction braking force is an example of the second braking force.

The vehicular braking device 1 controls the regenerative braking force and the friction braking force by inputting a predetermined braking request to the motor 2 and the hydraulic pump 19. The vehicular braking device 1 generates one or simultaneously both of the regenerative braking force by the motor 2 and the friction braking force by the friction brake 8 to apply a desired braking force to the vehicle V. A first response time Δt1, which is a response delay from when the braking request is input from the vehicular braking device 1 to the motor 2 to when the regenerative braking force according to the input is generated, is shorter than a second response time Δt2, which is a response delay from when the braking request is input from the vehicular braking device 1 to the hydraulic pump 19 to when the friction braking force according to the input is generated. Here, the braking request is information input to control the motor 2 and the hydraulic pump 19. Hereinafter, a braking request for the motor 2, a braking request for the hydraulic pump 19, or both, which is output to apply a desired braking force to the vehicle V, may be referred to as a braking request for the vehicle V.

The storage unit 31 stores a control profile indicating the transition of the target value of the regenerative braking force and the transition of the target value of the friction braking force. The control profile includes a target value F1(t) of the regenerative braking force and a target value F2(t) of the friction braking force at the control target point in time t, which is a point in time at which the vehicular braking device 1 performs control. The control unit 30 can derive the transition of the target value of the acceleration/deceleration of the vehicle V and the transition of the gradient of the acceleration/deceleration of the vehicle V based on the transition of the target value of the regenerative braking force and the transition of the target value of the friction braking force that are included in the control profile. Hereinafter, the target value of acceleration/deceleration of the vehicle V is referred to as requested acceleration/deceleration, and the gradient of acceleration/deceleration of the vehicle V is referred to as a requested gradient. The requested acceleration/deceleration is an example of a first parameter. The requested gradient is an example of a second parameter. There is a predetermined relationship between the requested acceleration/deceleration and the first response time Δt1 and between the requested gradient and the second response time Δt2. The control unit 30 can calculate the first response time Δt1 based on the requested acceleration/deceleration, and can calculate the second response time Δt2 based on the requested gradient. That is, in order to obtain an accurate response time, it is preferable to derive the response time based on a parameter corresponding to the braking device.

### (Function of Vehicular Braking Device)

The control unit 30 functions as the setting unit 100 and the generation unit 101 by executing a program stored in the storage unit 31.

In the setting unit 100, the control unit 30 derives the first response time Δt1 and the second response time Δt2 based on the control profile stored in the storage unit 31. The control unit 30 derives the transition of the target value of the acceleration/deceleration of the vehicle V based on the transition of the target value F1(t) of the regenerative braking force stored in the control profile. The control unit 30 derives the first response time Δt1 based on the derived transition of the target value of the acceleration/deceleration of the vehicle V. The control unit 30 derives the transition of the requested gradient of the vehicle V based on the transition of the target value F2(t) of the friction braking force stored in the control profile. The control unit 30 derives the second response time Δt2 based on the derived transition of the requested gradient of the vehicle V. The control unit 30 sets the lead time Δt based on the derived first response time Δt1 and second response time Δt2. Expression (1) is an example of an expression for setting a lead time Δt based on the first response time Δt1 and the second response time Δt2. x is a contribution ratio (distribution ratio) and is a ratio of the regenerative braking force (first braking force) to the braking force applied to the vehicle. The contribution ratio α is set to a value of 0 or more and 1 or less.

Δt=Δt×α+Δt2×(1−α) (1)

In the generation unit 101, the control unit 30 prefetches the control profile stored in the storage unit 31 based on the lead time Δt set by the setting unit 100 to generate a braking request S1(t) for the motor 2 and a braking request S2(t) for the hydraulic pump 19. In the generation unit 101, the control unit 30 acquires, from the control profile, a target value F1(t+Δt) of the regenerative braking force and a target value F2(t+Δt) of the friction braking force corresponding to a point in time t+Δt ahead of the control target point in time t by the lead time Δt. The control unit 30 generates the braking request S1(t) input to the motor 2 at the control target point in time t based on the acquired target value F1(t+Δt) of the regenerative braking force. The control unit 30 generates the braking request S2(t) input to the hydraulic pump 19 at the control target point in time t based on the acquired target value F2(t+Δt) of the friction braking force.

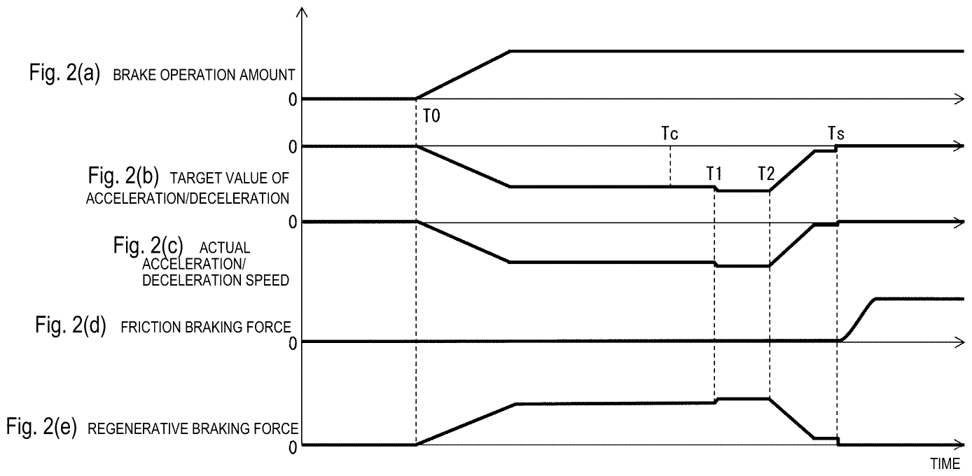

The setting unit 100 and the generation unit 101 will be described with reference to FIGS. 2(a)-2(e), 3(a)-3(e) and 4(a)-4(e). Hereinafter, it is assumed that the storage unit 31 stores a control profile for braking assistance control that reduces the swing of the vehicle V in the pitch direction occurring at the time of stopping.

FIG. 2(a)-2(e) are diagrams used for describing the braking assistance control. In the description using FIG. 2(a)-2(e), it is assumed that the contribution ratio α is 1 and the first response time Δt1 is 0. FIG. 2(a) illustrates an example of a temporal change in the brake operation amount. FIG. 2(b) illustrates a target value of acceleration/deceleration of the vehicle V in the braking assistance control. FIG. 2(c) illustrates an actual acceleration/deceleration of the vehicle V. FIG. 2(d) illustrates the friction braking force by the friction brake 8. FIG. 2(e) illustrates the regenerative braking force by the motor 2.

In the example illustrated in FIG. 2(a), the driver of the vehicle V starts operating the brake pedal 10 at timing T0. The actual acceleration/deceleration of the vehicle V changes according to the brake operation amount in the period from the timing T0 to the timing T1.

The control unit 30 functions as the setting unit 100 at the calculation start timing Tc after a predetermined time from the timing T0 at which the operation of the brake pedal 10 is started, and sets the lead time Δt (not illustrated in FIG. 2(a)-2(e)). The calculation start timing Tc is set to a timing after the timing T0 at which the operation of the brake pedal 10 is started and before the timing T1 (described later) at which the braking assistance control is started. In the example of FIG. 2(a)-2(e), since the contribution ratio α is 1 and the first response time Δt1 is 0, the lead time Δt is set to 0.

The control unit 30 acquires the target value F1(t) of the regenerative braking force from the control profile stored in the storage unit 31 at a predetermined time period. The control unit 30 functions as the generation unit 101 to generate the braking request S1(t) input to the motor 2 based on the acquired target value F1(t) of the regenerative braking force.

In the period from the timing T1 to the timing T2, the control unit 30 sets the target value of the acceleration/deceleration of the vehicle V to a value lower than the acceleration/deceleration according to the brake operation amount. In the period from the timing T1 to the timing T2, the braking force equal to or greater than the braking force corresponding to the brake operation amount is applied to the vehicle V.

In the period from the timing T2 to the timing T3, the control unit 30 gradually increases the target value of the acceleration/deceleration of the vehicle V to the vicinity of zero and gradually decreases the deceleration of the vehicle V.

In the period from the timing T3 to the timing Ts at which the vehicle V stops, the control unit 30 maintains the target value of the acceleration/deceleration of the vehicle V near zero. Since the acceleration/deceleration of the vehicle V is a value close to zero at the timing Ts when the vehicle V stops, the swing in the pitch direction occurring when the vehicle V stops is reduced.

After the vehicle V stops at the timing Ts, the control unit 30 maintains the stop state by the friction braking force of the friction brake 8. This is because regenerative energy is not generated in the stop state.

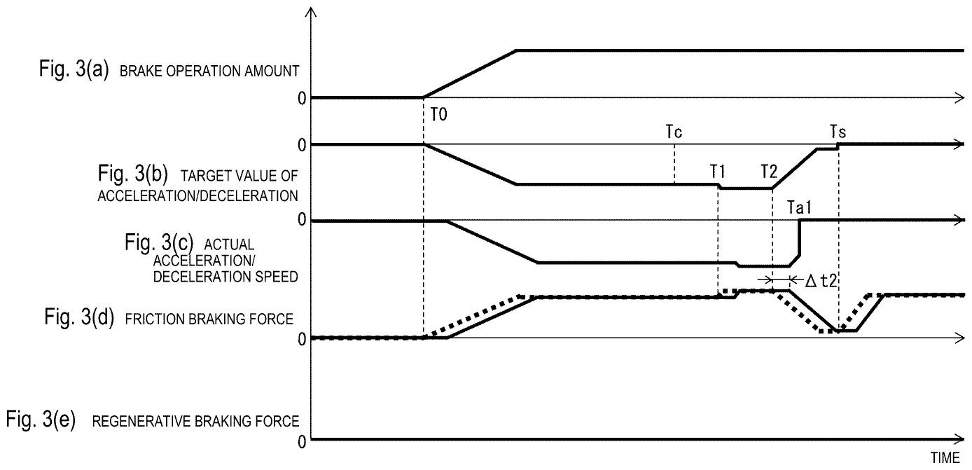

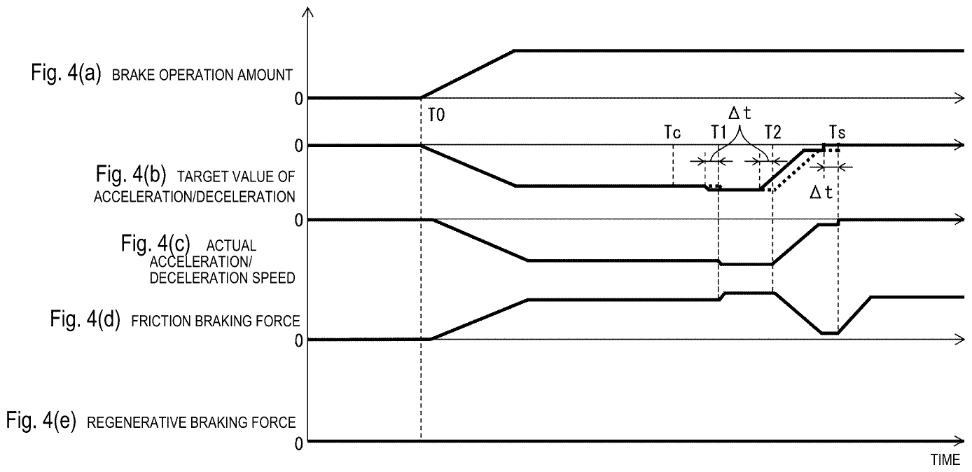

FIG. 3(a)-3(e) and FIG. 4(a)-4(e) are diagrams used to describe the braking assistance control, and stop the vehicle V using only the friction braking force. In the description using FIG. 3(a)-3(e), it is assumed that the contribution ratio α is 0 and the second response time Δt2 is larger than 0. For comparison, it is assumed that the lead time Δt set at the calculation start timing Tc is 0 in FIG. 3(a)-3(e) and Δt2 in FIG. 4(a)-4(e).

FIG. 3(a) and FIG. 4(a) illustrate an example of the temporal change of the brake operation amount as in FIG. 2(a). FIG. 3(e) and FIG. 4(e) illustrate the regenerative braking force by the motor 2.

FIG. 3(b) and FIG. 4(b) illustrate target values of acceleration/deceleration of the vehicle V in the braking assistance control. At the calculation start timing Tc, the control unit 30 functions as the setting unit 100 and sets the lead time Δt. In FIG. 3(b), after the calculation start timing Tc, since the lead time Δt is assumed to be 0, the control unit 30 acquires the target value F2(t) of the friction braking force from the control profile stored in the storage unit 31 to generate the braking request S2(t) at the control target point in time t based on the target value F2(t). On the other hand, in FIG. 4(b), after the calculation start timing Tc, the control unit 30 acquires the target value F2(t+Δt) of the friction braking force from the control profile stored in the storage unit 31 to generate the braking request S2(t) at the control target point in time t based on the target value F2(t+Δt).

In FIG. 3(d), the braking force corresponding to the braking request S2(t) input from the control unit 30 to the hydraulic pump 19 is indicated by a dotted line, and the friction braking force by the friction brake 8 actually generated is indicated by a solid line. The friction braking force actually generated is delayed by the second response time Δt2 as compared with the braking force corresponding to the braking request S2(t). On the other hand, in FIG. 4(d), since the braking request S2(t) is output in advance by the second response time Δt2, the target friction braking force is generated without a response delay.

FIG. 3(c) illustrates an actual acceleration/deceleration of the vehicle V. As illustrated in FIG. 3(c), since the response delay is generated by the second response time Δt2 until the friction braking force is generated after the control unit 30 inputs the braking request S2(t) to the hydraulic pump 19, the vehicle V stops at the timing Ta1 earlier than the target timing Ts. At the timing Ta1, since the hydraulic pressure is not fully released, the swing in the pitch direction occurs when the vehicle stops, and the occupant of the vehicle V easily feels uncomfortable. On the other hand, in FIG. 4(c), the actual acceleration/deceleration of the vehicle V transitions according to the control profile, and the vehicle V stops at the target timing Ts, and it is possible to reduce the swing in the pitch direction generated at the time of stopping.

### (Process of Vehicular Braking Device)

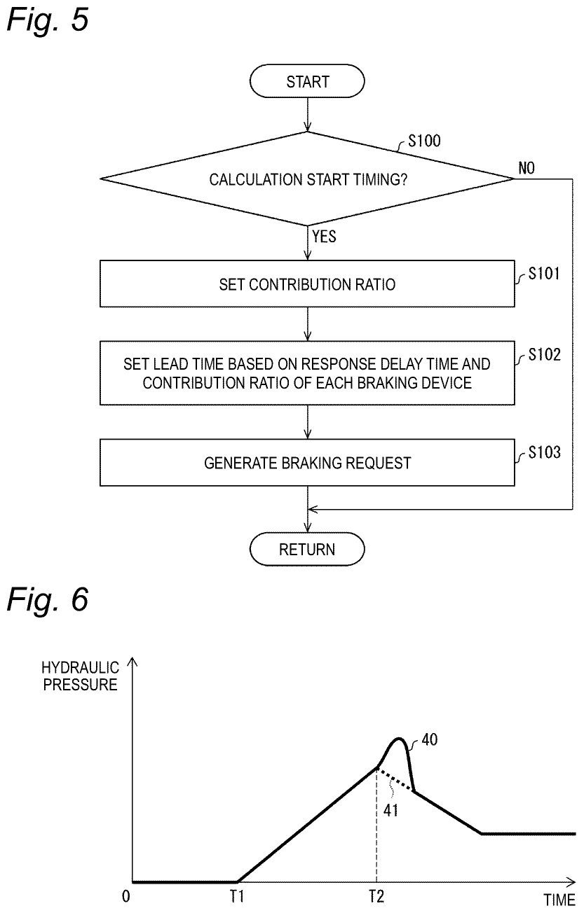

FIG. 5 is a flowchart illustrating a flow of processing of braking assistance control in the vehicular braking device according to the first embodiment of the present disclosure. A series of processes illustrated in FIG. 5 is repeatedly executed at a predetermined execution cycle by the control unit 30 while the vehicle V is traveling.

In S100, the control unit 30 determines whether it is the calculation start timing Tc. For example, when a predetermined time has elapsed since the driver of the vehicle V started to depress the brake pedal 10, the control unit 30 determines that the calculation start timing Tc has come (S100: YES), and the process proceeds to the process of S101. On the other hand, when the predetermined time has not elapsed since the driver of the vehicle V starts to depress the brake pedal 10, it is determined that the calculation start timing Tc has not been reached (S100: NO), and the process of this cycle is ended.

In S101, the control unit 30 functions as the setting unit 100 and sets the contribution ratio α. The contribution ratio α is set to, for example, a value obtained by dividing the requested braking force of the first braking device by the sum of the requested braking force of the first braking device and the requested braking force of the second braking device.

In S102, the control unit 30 functions as the setting unit 100, and sets the lead time Δt based on the first response time Δt1, the second response time Δt2, and the contribution ratio α set in S101. For example, the control unit 30 sets the lead time Δt by the above-described Expression (1).

In S103, the control unit 30 functions as the generation unit 101 to generate the braking request S1(t) for the motor 2 and the braking request S2(t) for the hydraulic pump 19 based on the lead time Δt set in S102. More specifically, the control unit 30 acquires, from the control profile stored in the storage unit 31, the target value F1(t+Δt) of the regenerative braking force and the target value F2(t+Δt) of the friction braking force corresponding to the point in time t+Δt ahead of the control target point in time t. Then, the control unit 30 generates the braking request S1(t) based on the target value F1(t+Δt) of the regenerative braking force, and generates the braking request S2(t) based on the target value F2(t+Δt) of the friction braking force. The control unit 30 inputs the generated braking request S1(t) to the motor 2, inputs the braking request S2(t) to the hydraulic pump 19, and ends a series of processes in this cycle.

### Second Embodiment

Another embodiment of the present disclosure will be described below. For convenience of description, members having the same functions as the members described in the above embodiment are denoted by the same reference numerals, and the description thereof will not be repeated.

In the first embodiment, in order to reduce the influence of the response time from the input of the braking request to the generation of the braking force on the braking control of the vehicle V, the generation unit 101 prefetches the control profile stored in the storage unit 31 based on the lead time Δt set by the setting unit 100. However, the technique of prefetching the control profile stored in the storage unit 31 can also be used to reduce events other than the influence of the response time from the input of the braking request to the generation of the braking force. For example, it can also be used to reduce the influence of overshoot occurring when the hydraulic pressure turns from increasing to decreasing.

FIG. 6 is a diagram used to describe the overshoot of the hydraulic pressure, and is a diagram illustrating the transition of the hydraulic pressure. FIG. 6 illustrates a transition of the hydraulic pressure when the hydraulic pressure starts increasing at timing T1 in FIG. 4(a)-4(e) and the hydraulic pressure changes from increasing to decreasing at timing T2 in FIG. 4(a)-4(e). At the timing T2 when the hydraulic pressure changes from increasing to decreasing, overshoot occurs, and the hydraulic pressure 40 greatly exceeding the target pressure 41 is generated for a predetermined time from the timing T2. Such overshoot of the hydraulic pressure may cause discomfort to the occupant of the vehicle V.

In order to reduce the influence of the overshoot of the hydraulic pressure, the control unit 30 may generate the braking request S2(t) in the generation unit 101 as follows.

At a predetermined calculation start timing before the timing T1 at which the increase in the hydraulic pressure starts, the control unit 30 derives the timing T2 at which the hydraulic pressure changes from increasing to decreasing as the timing at which the overshoot occurs based on the control profile stored in the storage unit 31. Then, the control unit 30 sets, as the prefetching time, the time between the timing T1 when the increase in the hydraulic pressure starts and the timing T2 when the overshoot occurs.

The control unit 30 generates a braking request obtained by subtracting the braking request corresponding to the braking force by the overshoot from the braking request S2(t) for the hydraulic pump 19 stored in the control profile for the period before the prefetching time from the timing T2 at which the overshoot occurs. As a result, even when the overshoot occurs, the hydraulic pressure does not exceed the target pressure 41 at the timing T2.

### Modification

In the above embodiments, the control profile indicates the target value of the braking force by a numerical value, but the present disclosure is not limited thereto. For example, a function in which the target value of the braking force is calculated by the function of time t may be used as the control profile.

In the first embodiment, the vehicular braking device 1 is applied to the vehicle V including the motor 2 that applies the regenerative braking force to the vehicle V and the friction brake 8 that applies the friction braking force to the vehicle V, and adjusts the regenerative braking force and the friction braking force. However, the braking force adjusted by the vehicular braking device 1 is not limited only to the regenerative braking force and the friction braking force. The braking device controlled by the vehicular braking device 1 is not limited only to the motor 2 and the friction brake 8. For example, the vehicular braking device 1 may control a friction brake having an electric caliper.

In the first embodiment described above, the control unit 30 generates both the braking request S1(t) for the motor 2 and S2(t) for the hydraulic pump 19 based on the lead time Δt set in S102 of FIG. 5 (S103). However, the lead time for generating the braking request S1(t) for the motor 2 and the lead time for generating S2(t) for the hydraulic pump 19 may be individually set. For example, the control unit 30 may set the lead time for generating the braking request S1(t) for the motor 2 based on the first response time Δt1, and set the lead time for generating S2(t) for the hydraulic pump 19 based on the second response time Δt2.

### Summary

A vehicular braking device according to an aspect of the present disclosure is applied to a vehicle including a first braking device having a relatively short response time from an input of a braking request to generation of a braking force to be applied to the vehicle and a second braking device having a relatively long response time, and adjusts a first braking force generated by the first braking device and a second braking force generated by the second braking device to apply, to the vehicle to the vehicle, a braking force corresponding to a braking request, the vehicular braking device includes a storage unit that stores a control profile indicating transitions of target values of the first braking force and the second braking force during a control target period, and a setting unit that derives a first response time that is the response time of the first braking device and a second response time that is the response time of the second braking device at a control target point in time based on the control profile stored in the storage unit, and sets a lead time based on the first response time and the second response time, and a generation unit that generates a braking request for the first braking device and the second braking device based on target values of the first braking force and the second braking force corresponding to a point in time ahead of the control target point in time by the lead time set by the setting unit in the control profile stored in the storage unit.

In recent years, various types of braking devices have been put into practical use, and various types of braking devices have been proposed. The braking devices of different types have different response times in particular. For example, a regenerative brake having a motor for controlling regenerative torque tends to have a relatively short response delay, and a hydraulic brake tends to have a relatively long response delay at the start of releasing and the start of raising of hydraulic pressure. In a vehicular braking device in which a hydraulic brake and a regenerative brake are mixed, there is a possibility that the vehicular braking device cannot exhibit targeted performance unless a response delay is considered according to a distribution ratio of the hydraulic brake and the regenerative brake.

According to the present disclosure, the first response time and the second response time are prefetched according to the target values of the first braking device and the second braking device at the control target point in time, and the requested braking force is led by the lead time derived based on the first response time and the second response time. As a result, even when the two braking devices have different response times and the target values of the first braking device and the second braking device change from moment to moment, it is possible to suppress variations in control and to perform braking control with high accuracy.

In the vehicular braking device according to an aspect of the present disclosure, in the setting unit, a first parameter required to derive the first response time and a second parameter required to derive the second response time are different from each other.

According to the present disclosure, even when the first braking device and the second braking device have different parameters that are dominant over the response time, the lead control can be performed in one dimension of time.

In the vehicular braking device according to an aspect of the present disclosure, the setting unit further sets a contribution ratio that is a ratio of the first braking force to the braking force applied to the vehicle, and sets the lead time based on the contribution ratio, the first response time, and the second response time.

There is a braking force that cannot be applied to the vehicle under a specific condition such as stopping, such as a regenerative braking force. According to the present disclosure, the lead time can be set with high accuracy by setting the lead time based on the contribution ratio.

The second braking device is a friction brake that generates a friction braking force by hydraulic pressure and causes overshoot when the hydraulic pressure changes from increasing to decreasing, and includes a storage unit that stores a control profile indicating a transition of the friction braking force, a second setting unit that derives timing at which the overshoot occurs and sets a prefetching time based on the control profile stored in the storage unit, and a second generation unit that generates a braking request obtained by reducing a braking request corresponding to a braking force by the overshoot from a braking request for the friction brake for the period before the prefetching time from the timing.

According to the present disclosure, braking control can be performed with high accuracy.

### ADDITIONAL REMARK

The present disclosure is not limited to the above-described embodiments, and various modifications can be made within the scope indicated in the claims, and embodiments obtained by appropriately combining technical means disclosed in different embodiments are included in the technical scope of the present disclosure.

1. A vehicular braking device that is applied to a vehicle including a first braking device having a relatively short response time from an input of a braking request to generation of a braking force to be applied to the vehicle and a second braking device having a relatively long response time, and adjusts a first braking force generated by the first braking device and a second braking force generated by the second braking device to apply, to the vehicle to the vehicle, a braking force corresponding to a braking request, the vehicular braking device comprising:
a storage unit that stores a control profile indicating transitions of target values of the first braking force and the second braking force during a control target period; and
a setting unit that derives a first response time that is the response time of the first braking device and a second response time that is the response time of the second braking device at a control target point in time based on the control profile stored in the storage unit, and sets a lead time based on the first response time and the second response time; and
a generation unit that generates a braking request for the first braking device and the second braking device based on target values of the first braking force and the second braking force corresponding to a point in time ahead of the control target point in time by the lead time set by the setting unit in the control profile stored in the storage unit.

2. The vehicular braking device according to claim 1, wherein in the setting unit, a first parameter required to derive the first response time and a second parameter required to derive the second response time are different from each other.

3. The vehicular braking device according to claim 1, wherein the setting unit further sets a contribution ratio that is a ratio of the first braking force to the braking force applied to the vehicle, and sets the lead time based on the contribution ratio, the first response time, and the second response time.
